(19) United States
(12) Patent Application Publication
(10) Pub. No.: US 2011/0026818 A1
(43) Pub. Date: Feb. 3, 2011

(54) System and method for correction of backlit face images

(76) Inventors: Jonathan Yen, San Jose, CA (US); William C. Kress, Mission Viejo, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/800,484

(22) Filed: May 17, 2010

Related U.S. Application Data
(60) Provisional application No. 61/229,878, filed on Jul. 30, 2009.

(51) Int. Cl. G06K 9/00

(52) U.S. Cl. 382/165; 382/170

(57) ABSTRACT

The subject application is directed to a system and method for backlit face image correction. Image data is first received that includes at least one facial region that defines an image human face. At least one facial region is detected via a processor that operates in accordance with software and an associated data storage. Skin tone characteristics of the at least one facial region are then detected. Pixel count data and histogram data are then calculated from the received image data. A plateau is then detected in a function of the pixel count data relative to the histogram data. A correction factor, based upon a property of the detected plateau, is then calculated. Pixel values of the at least one facial region are adjusted in accordance with the calculated correction factor. Thereafter, a corrected image is output that includes adjusted pixel values corresponding to at least one facial region.

### CROSS-REFERENCE TO RELATED APPLICATIONS

This application is related and claims priority to U.S. Provisional Patent Application Ser. No. 61/229,878, filed on Jul. 30, 2009 titled SYSTEM AND METHOD FOR AUTOMATIC BACKLIT FACE CORRECTION, the entirety of which is incorporated herein.

### BACKGROUND OF THE INVENTION

The subject application is directed generally to detection of characteristics in electronically encoded images. The application is particularly applicable to detection of one or more portions of an electronic image wherein an object is backlit.

Early image capturing systems involved shutters, lenses, and photo-sensitive material that was chemically changed when exposed to light. More recently, image capture is done with digital imaging devices, such as digital cameras or scanners. Acquired images, particularly those that result from real life images, such as may be acquired by digital cameras or scans of photographs, are often captured in non-optimal situations. Problems associated with earlier image capturing operations are also present with digitally acquired images. One such situation is presented with backlighting. A relatively bright backlighting tends to wash out or obscure objects in a forefront of such lighting. The relative intensity of the backlit area to the lighting of the object can wash out or otherwise obscure the features in the object. Backlighting is particularly problematic with human subjects insofar is it can result in obscured facial characteristics.

Early attempts at obfuscating the effects of backlighting included repositioning a subject relative to the light and image capturing device, such as a camera. By way of example, a photographer may reorient a person so that the sun is to the photographer's back and the subject is positioned to his front. In other situations, a photographer may use a flash to give better illumination of a subject relative to the backlighting.

Electronic images resultant from today's imaging equipment exist in many formats. By way of example, images may be acquired or stored in various schemes, including RAW, JPEG, GIF, TIFF or PCX, as well as many other image data types. Many image data encoding schemes define images in connection with a multidimensional color space, such as a space defined by either additive or subtractive primary colors. Such color spaces include red-green-blue (RGB); cyan, magenta, yellow (CYM), which is sometimes encoded with a blac(K) component as CMYK. Given the encoded nature of such captured images, it is possible to perform analysis and manipulation of underlying image data.

### SUMMARY OF THE INVENTION

In accordance with one embodiment of the subject application, there is provided a system and method for backlit face image correction. Image data is first received that includes at least one facial region that defines an image human face. Via a processor that operates in accordance with software and an associated data storage, at least one facial region is detected and skin tone characteristics of the at least one facial region are then detected. Pixel count data and histogram data are then calculated from the received image data. A plateau is then detected in a function of the pixel count data relative to the histogram data. Based upon a property of the detected plateau, a correction factor is then calculated. Pixel values of the at least one facial region are adjusted based upon the calculated correction factor. A corrected image is then output that includes adjusted pixel values corresponding to at least one facial region.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawings will be provided by the Office upon request and payment of the necessary fee. The subject application is described with reference to certain figures, including:

FIG. 1 is an overall diagram of a backlit face image correction system according to one embodiment of the subject application;

FIG. 2 is a block diagram illustrating device hardware for use in the backlit face image correction system according to one embodiment of the subject application;

FIG. 3 is a functional diagram illustrating the device for use in the backlit face image correction system according to one embodiment of the subject application;

FIG. 4 is a block diagram illustrating controller hardware for use in the backlit face image correction system according to one embodiment of the subject application;

FIG. 5 is a functional diagram illustrating the controller for use in the backlit face image correction system according to one embodiment of the subject application;

FIG. 6 is a diagram illustrating a workstation for use in the backlit face image correction system for according to one embodiment of the subject application;

FIG. 7 is a block diagram illustrating a backlit face image correction system according to one embodiment of the subject application;

FIG. 8 is a functional diagram illustrating a backlit face image correction system according to one embodiment of the subject application;

FIG. 9 is a flowchart illustrating a method for backlit face image correction according to one embodiment of the subject application;

FIG. 10 is a flowchart illustrating a method for backlit face image correction according to one embodiment of the subject application;

FIG. 11 is a flowchart illustrating a method for backlit face image correction according to one embodiment of the subject application;

FIG. 12 is an example of a backlit input image and associated corrected output image in accordance with the system for backlit face image correction according to one embodiment of the subject application;

FIG. 13 illustrates an input image and associated face detection result in accordance with the system for backlit face image correction according to one embodiment of the subject application;

FIG. 14 is another example the input image of FIG. 13 with a region-of-interest mask applied to the image in accordance with the system for backlit face image correction according to one embodiment of the subject application;

FIG. 15 is further example of the input image of FIG. 13 and the region-of-interest mask and face detection results in accordance with the system for backlit face image correction according to one embodiment of the subject application;

FIG. 16 is an example input image illustrating a backlit face in accordance with the system for backlit face image correction according to one embodiment of the subject application;

FIG. 17 is another example input image illustrating multiple faces including one backlit face in accordance with the system for backlit face image correction according to one embodiment of the subject application;

FIG. 18 is an example of an input image, face detection result, and cropped facial region in accordance with the system for backlit face image correction according to one embodiment of the subject application;

FIG. 19 depicts an example severity categorization chart for use with the system for backlit face image correction according to one embodiment of the subject application;

FIG. 20 illustrates an example face having a darker ethnicity and the corresponding degrees of overlap in accordance with the system for backlit face image correction according to one embodiment of the subject application;

FIG. 21 illustrates tone reproduction curves for sectional bulging for brightness and bulging for saturation in accordance with the system for backlit face image correction according to one embodiment of the subject application;

FIG. 22 is an example input image and associated normalized histogram with plateau in accordance with the system for backlit face image correction according to one embodiment of the subject application;

FIG. 23 illustrates a tone reproduction curve and plateau of the image of FIG. 22 in accordance with the system for backlit face image correction according to one embodiment of the subject application;

FIG. 24 illustrates another tone reproduction curve of the input image of FIG. 22 in accordance with the system for backlit face image correction, according to one embodiment of the subject application.

### DETAILED DESCRIPTION OF THE PREFERRED EMBODIMENT

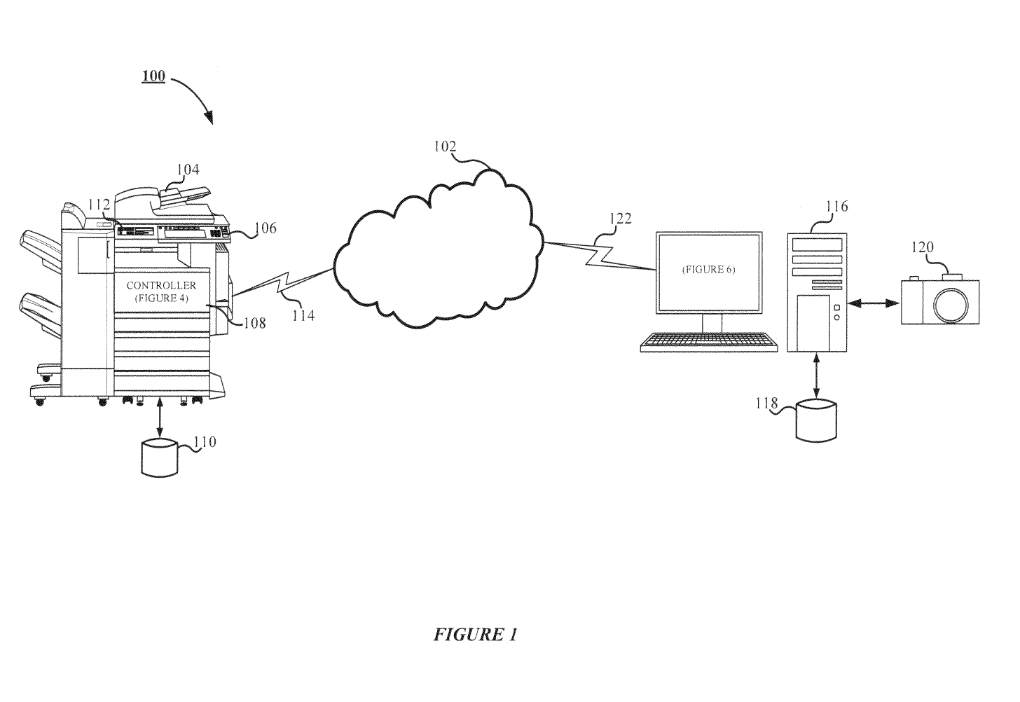

The subject application is directed to a system and method for backlit face image correction. In particular, the subject application is directed to a system and method for the enhancement of the faces of human subjects depicted in electronic images. More particularly, the subject application is directed to a system and method for automatically correcting backlit faces of human subjects in an input image. It will become apparent to those skilled in the art that the system and method described herein are suitably adapted to a plurality of varying electronic fields employing data detection and correction, including, for example and without limitation, communications, general computing, data processing, document processing, financial transactions, vending of products or services, or the like. The preferred embodiment, as depicted in FIG. 1, illustrates a document or imaging processing field for example purposes only and is not a limitation of the subject application solely to such a field.

Referring now to FIG. 1, there is shown an overall diagram of a type system 100 for backlit face image correction in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

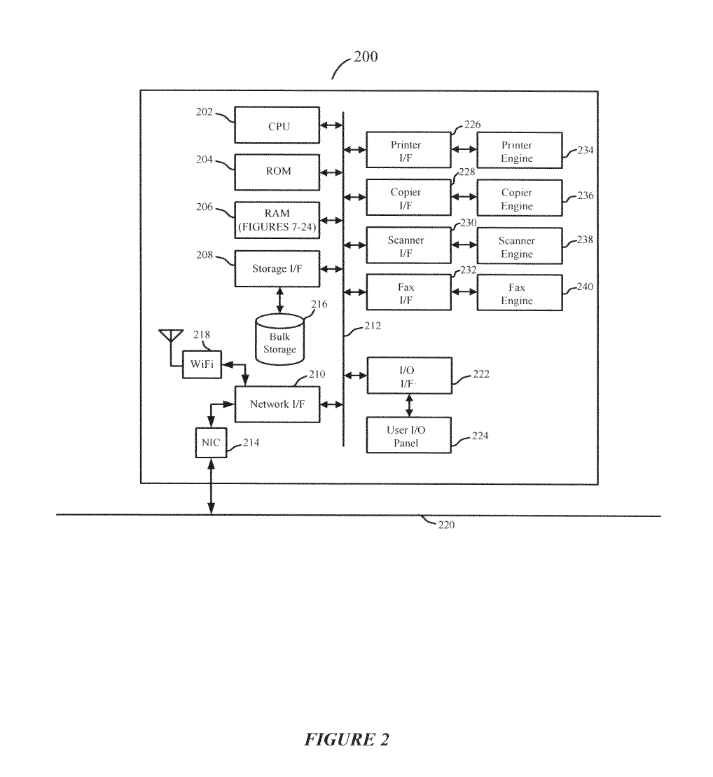

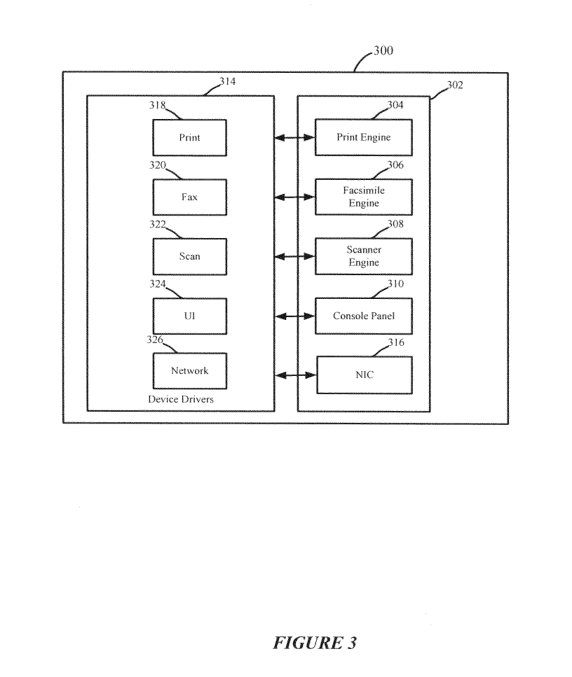

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

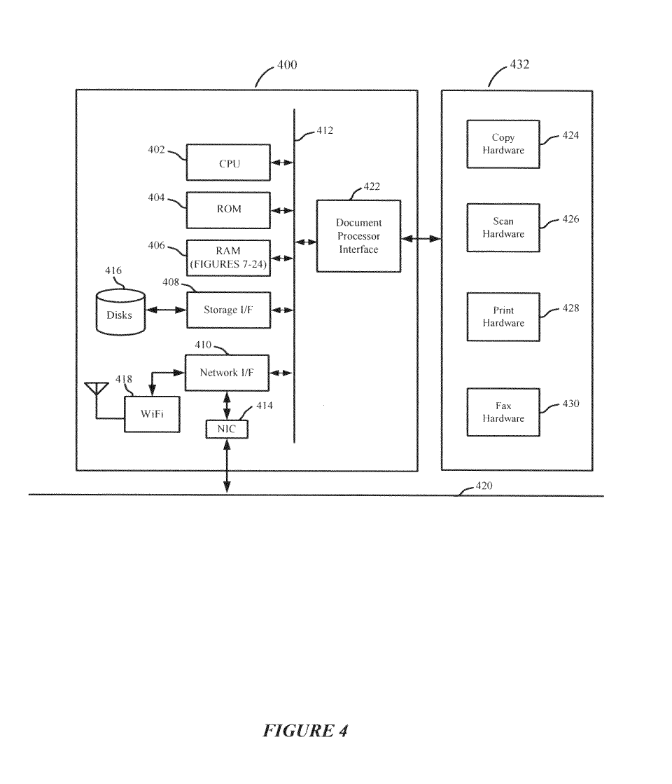

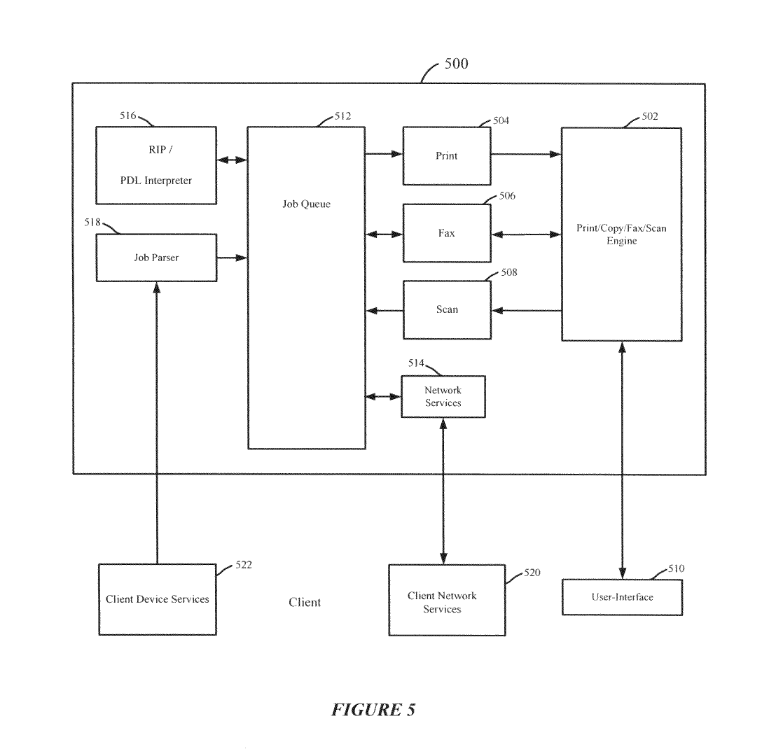

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for backlit face image correction. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like. The document processing device of FIG. 1 also includes a portable storage device reader 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is a user device, illustrated as a computer workstation 116 in data communication with the computer network 102 via a communications link 122. It will be appreciated by those skilled in the art that the computer workstation 116 is shown in FIG. 1 as a workstation computer for illustration purposes only. As will be understood by those skilled in the art, the computer workstation 116 is representative of any personal computing device known in the art including, for example and without limitation, a laptop computer, a personal computer, a personal data assistant, a web-enabled cellular telephone; a smart phone, a proprietary network device, or other web-enabled electronic device. According to one embodiment of the subject application, the workstation 116 further includes software, hardware, or a suitable combination thereof configured to interact with the document processing device 104, or the like.

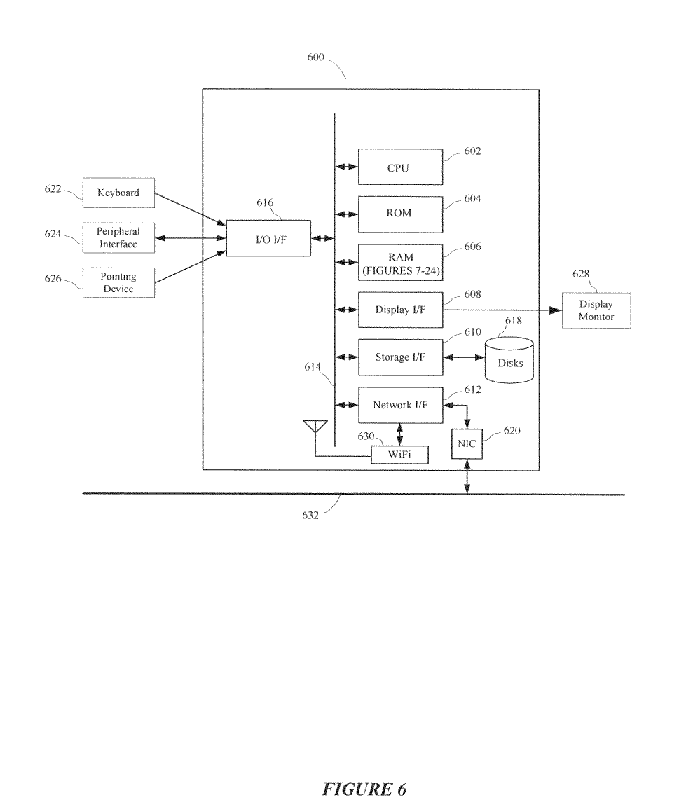

The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the computer workstation 116 is suitably adapted to provide document data, job data, user interface data, image data, monitor document processing jobs, employ thin-client interfaces, generate display data, generate output data, or the like, with respect to the document rendering device 104, or any other similar device coupled to the computer network 102. The functioning of the computer workstation 116 will better be understood in conjunction with the block diagram illustrated in FIG. 6, explained in greater detail below.

Communicatively coupled to the computer workstation 116 is a suitable memory, illustrated in FIG. 1 as the data storage device 118. According to one embodiment of the subject application, the data storage device 118 is any mass storage device known in the art including, for example and without limitation, magnetic storage drives, a hard disk drive, optical storage devices, flash memory devices, or any suitable combination thereof. In accordance with one embodiment of the subject application, the data storage device 118 is suitably adapted to store scanned image data, modified image data, document data, image data, color processing data, or the like. It will be appreciated by those skilled in the art that while illustrated in FIG. 1 as being a separate component of the system 100, the data storage device 118 is capable of being implemented as an internal storage component of the computer workstation 116, such as, for example and without limitation, an internal hard disk drive, or the like

Additionally, the system 100 of FIG. 1 depicts an image capture device, illustrated as a digital camera 120 in data communication with the workstation 116. The skilled artisan will appreciate that the camera 120 is representative of any image capturing device known in the art, and is capable of being in data communication with the document processing device 104, the workstation 116, or the like. In accordance with one embodiment of the subject application, the camera 120 is capable of functioning as a portable storage device via which image data is received by the workstation 116, as will be understood by those skilled in the art.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the computer workstation 116, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

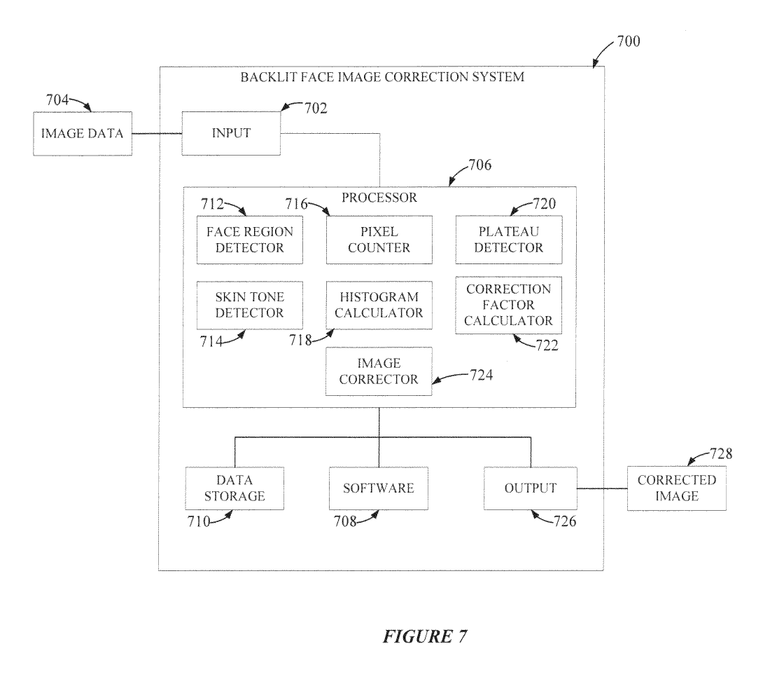

Turning now to FIG. 7, illustrated is a block diagram of a system 700 for backlit face image correction in accordance with one embodiment of the subject application. The system 700 includes an input 702 that is configured to receive image data 704 that includes one or more facial regions that define an image human face. The system 700 further includes a processor 706 that operates in accordance with software 708 and an associated data storage 710. The processor 706 is programmed with instructions so as to include a face region detector 712, a skin tone detector 714, a pixel counter 716, a histogram calculator 718, a plateau detector 720, a correction factor calculator 722, and an image corrector 724.

The face region detector 712 of the processor 706 is configured to detect the facial regions, while the skin tone detector 714 is configured to detect the skin tone characteristics of the one or more facial regions. The pixel counter 716 calculates the pixel count data from the received image data 704, and the histogram calculator is configured to calculate histogram data from the received image data 704. The plateau detector 720 included in the processor 706 facilitates the detection of a plateau in a function of pixel count data relative to histogram data. The correction factor calculator 722 is configured to calculate a correction factor based upon a property of a detected plateau, and the image corrector 724 functions to adjust pixel values of the one or more facial regions based upon the calculated correction factor. The system 700 further includes an output 726 that is configured to output a corrected image 728 that includes of adjusted pixel values corresponding to one or more facial regions.

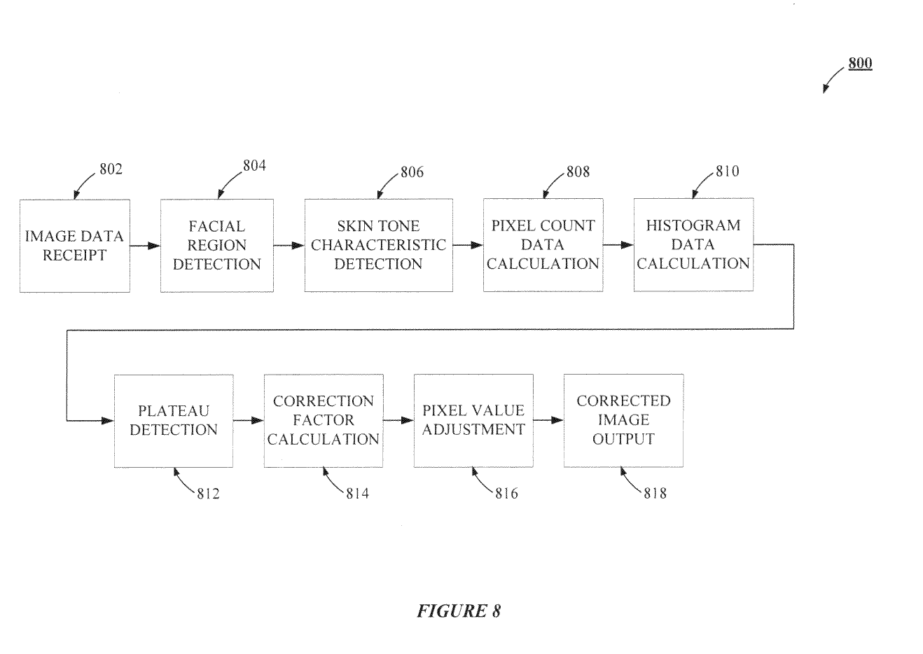

Referring now to FIG. 8, there is shown a functional diagram illustrating the system 800 for backlit face image correction in accordance with one embodiment of the subject application. As shown in FIG. 8, image data receipt 802 is performed of an image that includes at least one facial region that defines an image human face. Next, facial region detection 804 is performed of at least one facial region. Skin tone characteristics detection 806 then occurs of skin tones of the facial region.

Pixel count calculation 808 and histogram data calculation 810 are then performed in accordance with the image data. Plateau detection 812 then occurs of a plateau in a function of the calculated pixel count relative to the histogram data. Correction factor calculation 814 is performed to calculate a correction factor based upon a property of a plateau detected via the plateau detection 812. Pixel value adjustments 816 are then performed of pixel values of the at least one facial region using the correction factor calculated via the calculation 814. Corrected image output 818 occurs of an image corrected via adjusted pixel values corresponding to the facial region.

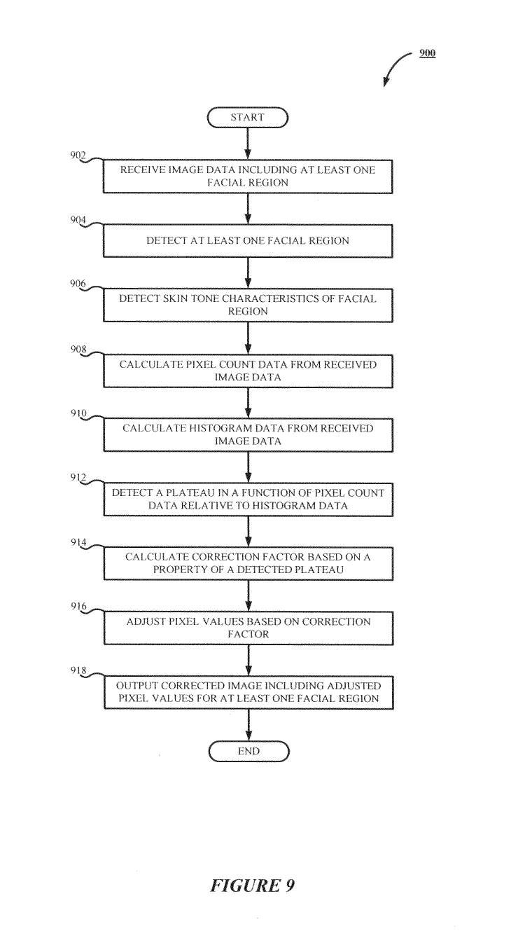

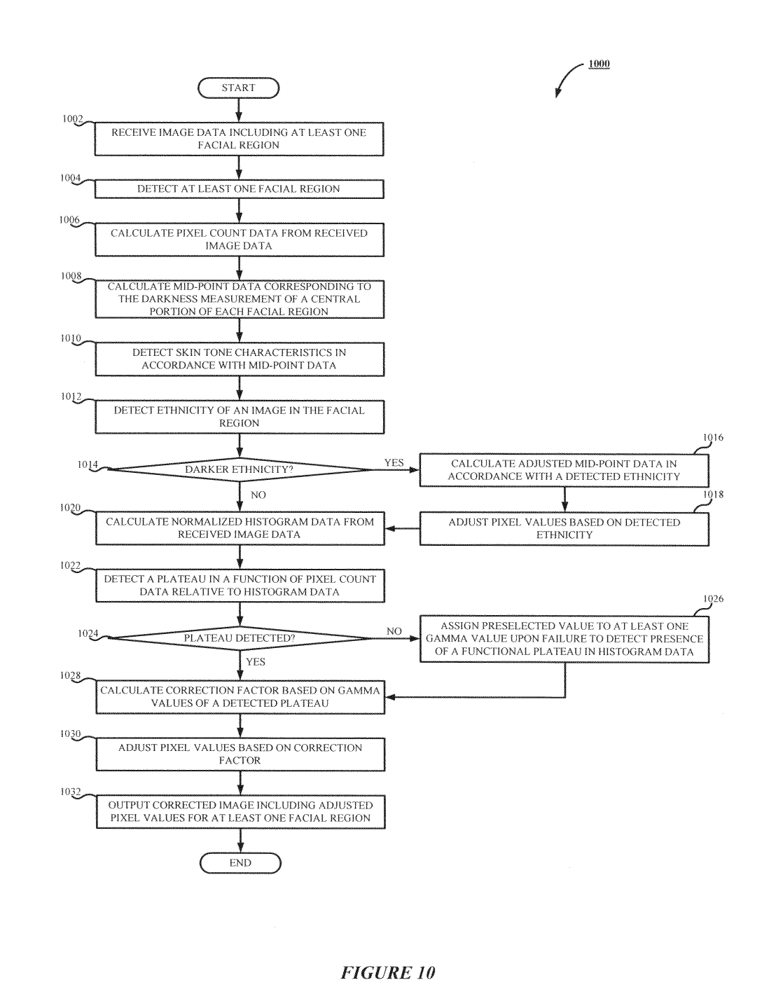

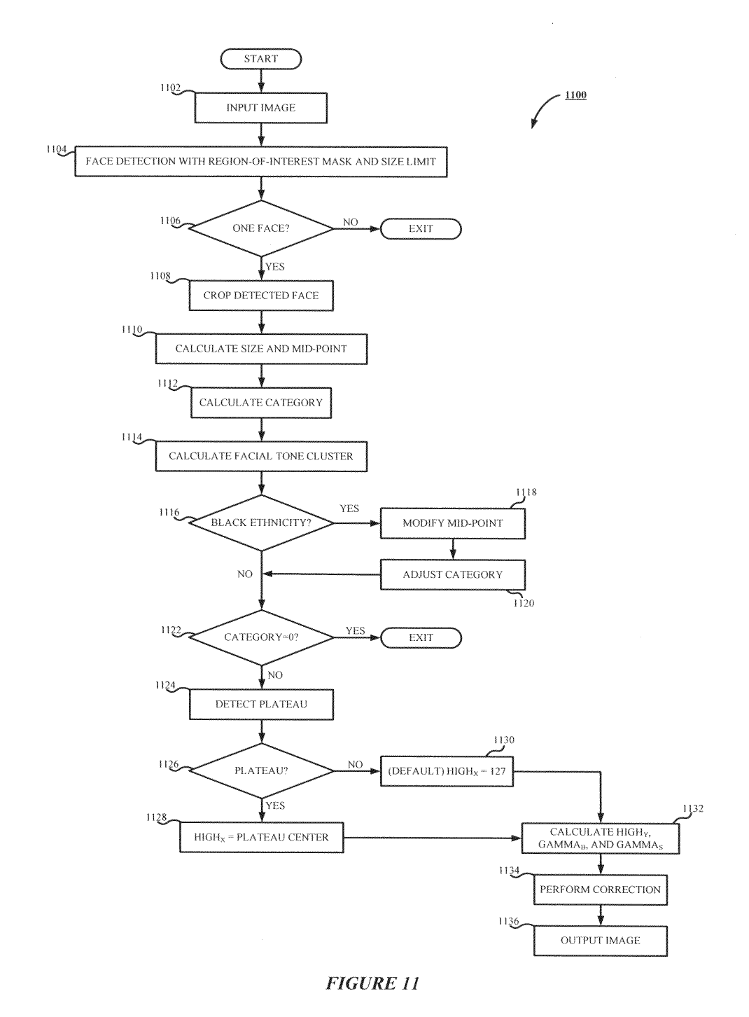

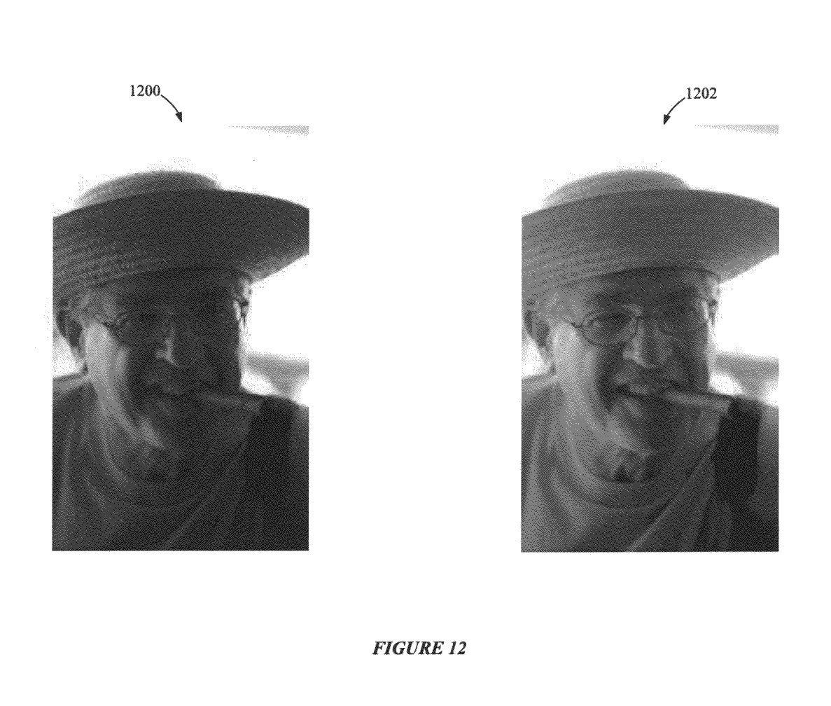

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9, FIG. 10, and FIG. 11, as well as the example implementations illustrated in FIGS. 12-24. Turning now to FIG. 9, there is shown a flowchart 900 illustrating a method for backlit face image correction in accordance with one embodiment of the subject application. Beginning at step 902, image data is received that includes at least one facial region that defines an image human face.

At step 904, a processor operating in accordance with software and an associated data storage detects the at least one facial region. Skin tone characteristics of the at least one facial region are then detected at step 906. At step 908, pixel count data is calculated from the received image data. Histogram data is then calculated, at step 910, from the received image data. A plateau is then detected in a function of the pixel count data relative to the histogram data at step 912. A correction factor is then calculated based upon a property of the detected plateau at step 914. At step 916, pixel values of the at least one facial region are adjusted based upon the calculated correction factor. At step 918, a corrected image is output that includes adjusted pixel values corresponding to at least one facial region.

Referring now to FIG. 10, there is shown a flowchart 1000 illustrating a method for backlit face image correction in accordance with one embodiment of the subject application. The methodology of FIG. 10 begins at step 1002, whereupon image data that includes at least one facial region is received by the controller 108, the user device 116, or other suitable processing component associated with the digital image enhancement system 100 of the subject application. It will be appreciated by those skilled in the art that such image data is capable of being received via operation of the document processing device 104, the user device 116, the image capture device (camera 120), or the like.

At step 1004, at least one facial region is detected from the input image data that was received at step 1002. Those skilled in the art will appreciate that any suitable method of facial detection is capable of being employed in accordance with the methodology of the example in FIG. 10. The pixel count from the received image data is then calculated at step 1006. At step 1008, mid-point data corresponding to the darkness measurement of a central portion of at least one facial region is then calculated by the controller 108, the user device 116, or other such device in accordance with the subject application. In accordance with one embodiment of the subject application, the mid-point data is representative of the relative darkness of a detected facial region, as discussed in greater detail below. Thus, at step 1010, skin tone characteristics are detected based upon the calculated mid-point data.

The ethnicity of the image in the facial region is then detected at step 1012. It will be appreciated by those skilled in the art that the ethnicity of a given image is capable of being grouped into a lighter (European) ethnicity or a darker (African/Indian) ethnicity. A determination is then made at step 1014 whether the detected ethnicity is a darker ethnicity. Upon a positive determination at step 1014, flow proceeds to step 1016, whereupon adjusted mid-point data is calculated. In accordance with one example embodiment of the subject application, the value of the mid-point is increased by 50%. The pixel values of the input image are then adjusted in accordance with the detected ethnicity and adjusted mid-point at step 1018.

After adjustment of the pixel values based upon ethnicity at step 1018, or following a determination at step 1014 that the facial region is not of a darker ethnicity, flow proceeds to step 1020. The normalized histogram is then calculated at step 1020 from the received image data. It will be appreciated by those skilled in the art that the normalization of the histogram associated with the received image data reduces noise inherent in the image. Plateau detection is then performed at step 1022 of a plateau in a function of the pixel count data relative to the histogram. A more detailed explanation of the plateau is illustrated below with respect to FIGS. 11-24. A determination is then made at step 1024 whether a plateau has been detected in the normalized histogram. When no plateau is detected by the controller 108, the user device 116, or other suitable processing device, flow proceeds to step 1026.

At step 1026, a preselected value is assigned to one or more Gamma values in response to the failure to detect a plateau in the histogram. A suitable value for substitution is described in greater detail below with respect to FIGS. 11-24. Following plateau detection at step 1024, or after assigning the preselected value, operations proceed to step 1028. At step 1028, the controller 108, the user device 116, or other suitable processing device implementing the methodology of FIG. 10 calculates a correction factor based upon the Gamma values of the detected plateau. The pixel values for the facial region are then adjusted based upon the calculated correction factor at step 1030. That is, the pixel values for the backlit face are adjusted to correct for the backlighting in accordance with the calculated correction factor. At step 1032, the corrected image including the adjusted pixel values for the facial region are then output for printing, storage, communication, etc.

Turning now to FIG. 11, there is shown a method 1100 for automatic backlit face correction in accordance with one embodiment of the subject application. As shown in FIG. 11, the method 1100 begins at step 1102, whereupon an image is input in the document processing device 104, the user device 116, or other suitable processing device, as will be appreciated by those skilled in the at capable of implementing the methodology of FIG. 11. FIG. 12 shows an example of an input image 1200 and the corresponding output image 1202 after implementation of the automatic backlit face correction of the subject application.

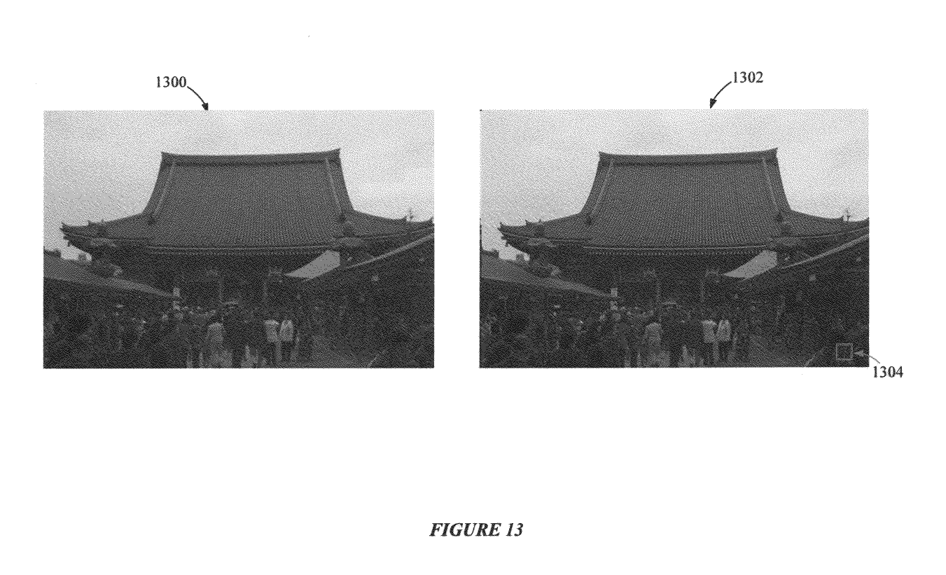

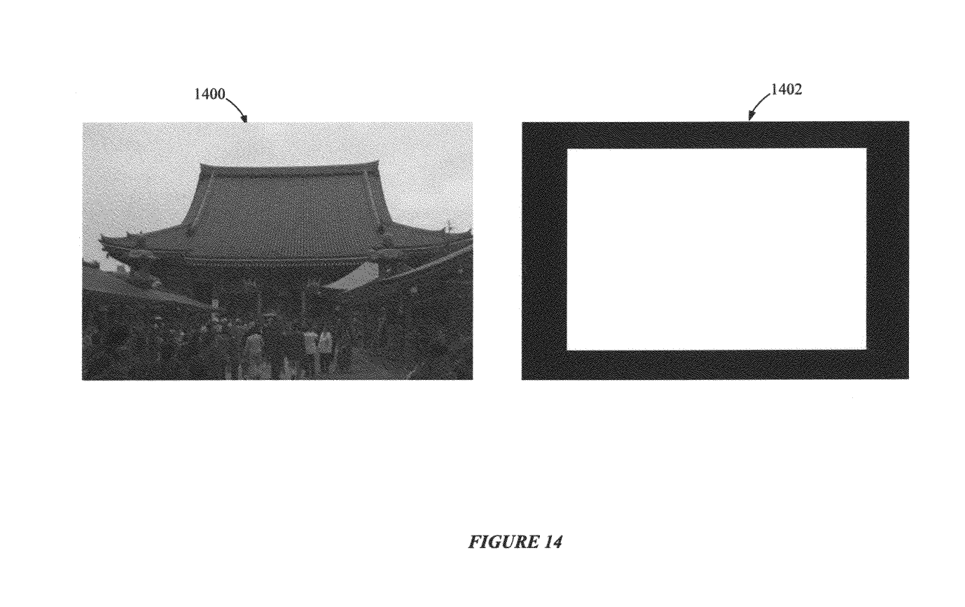

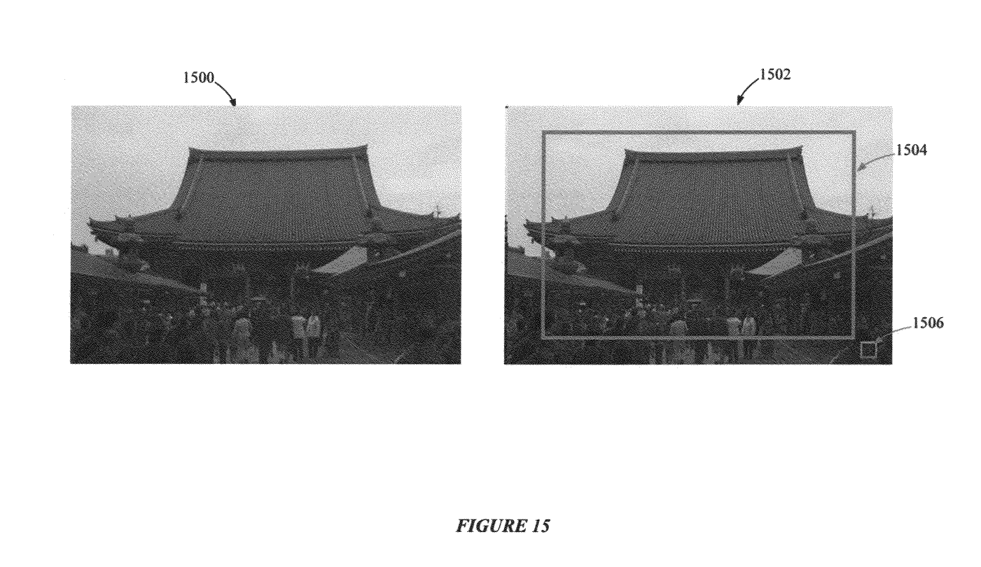

At step 1104, face detection with a region of interest mask and size limit is applied to a given input image. Suitable methods for face detection include, for example and without limitation, the masking of input images to mask those pixels in an input image that do not have a skin tone color associated with them. Such a method further employs a region of interest scheme, which specifies the regions of the input image in which such facial detection is to be performed, as detailed in commonly assigned, co-pending U.S. patent application Ser. No. 12/583,625, filed on Aug. 24, 2009, the entirety of which is incorporated herein. This approach effectively blocks facial detection of faces near the edges of an input image. For example, given an input image, the minor dimension is determined, i.e., the smaller of the width and the height, and a scaling factor is calculated such that the minor dimension is scaled down to no bigger than, e.g. 480, if necessary. For example, if the input image is a typical 3 MB consumer photo, i.e., 1200 pixels (height) by 1600 pixels (width), then its minor dimension is 1200, and the scaling factor is 2.5. The scaled-down dimensions will be 480 pixels by 640 pixels. Next, a binary image is created of the same dimensions as the original image or of the scaled-down dimensions if necessary. Each pixel in the binary image is set it to 0 if it is not in the Region of Interest (for example, at the 10% peripheral regions), otherwise it is set 1. The binary image is then scaled up to the original input image dimensions if necessary to be the ROI mask, and send the mask to the face detector. FIG. 13 illustrates an input image 1300 and a face detection result 1302, in which one face 1304 has been detected. The use of the Region of Interest mask, as contemplated herein, is applied in the face detection to mask off the faces at the peripheral regions, e.g., 1/10 of the image peripheral region. FIG. 14 illustrates the input image 1400 and a corresponding region-of-interest mask 1402, whereas FIG. 15 depicts the input image 1500 and the face detection results 1502 in accordance with the applied mask 1504.

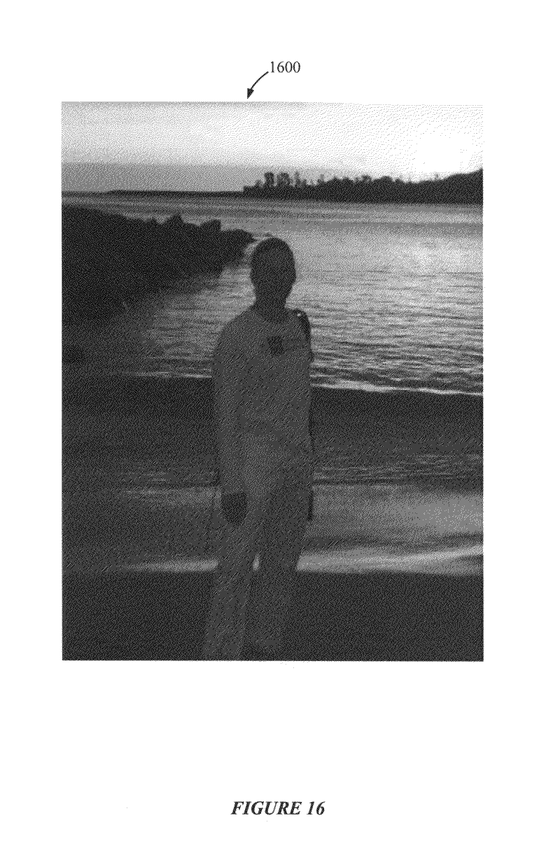

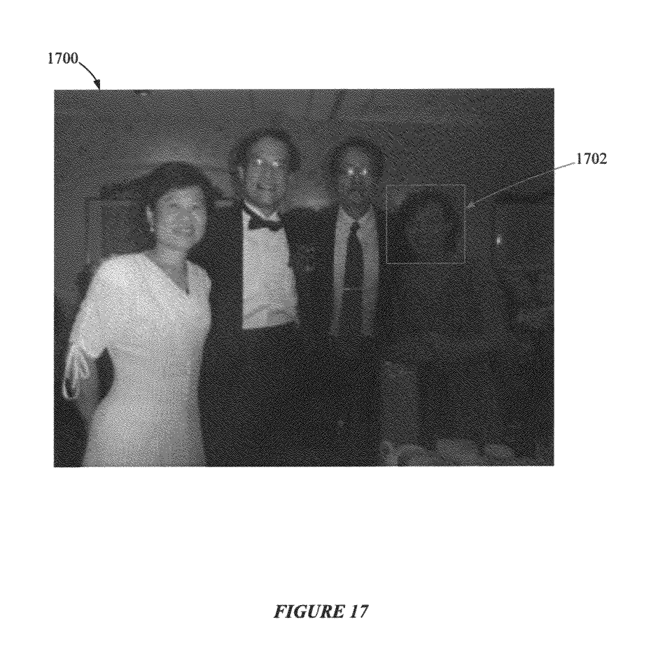

As shown in FIG. 15, the detected face 1506 is covered by the mask 1504, such that backlit correction is not applied to the face 1506. The size limit is also imposed in the face detection to rule out faces that are too small, e.g. face width is less than 10% of the minor image dimension, as illustrated in the backlit image 1600 of FIG. 16. In accordance with one embodiment of the subject application, the automatic backlit face correction of the subject application is not applied to backlit faces that are among multiple faces detected in one single image. That is, as shown in FIG. 17, the input image 1700 includes four faces, with one face (identified at 1702) as backlit, indicating a preference that the input image 1700 be subjected to other forms of backlit image correction. For example and without limitation, those images with backlit faces that are at the peripheral regions, too small or among multiple faces are corrected as backlit scenes, not as backlit faces because, as will be appreciated by one skilled in the art, it is suggested that the amount of the backlit correction be based on criteria other than the face. The skilled artisan will appreciate, however, that while reference is made in the example embodiments of FIG. 11-24 as directed to automatic backlit face correction on images having only a single human face, the subject methodology as previously discussed, is capable of application to multiple faces. For example purposes only, the automatic backlit face correction methodology of FIGS. 11-24 is applied only to portrait scenes, i.e. those images in which a human face is the primary subject thereby avoiding the application of the system and method described above to faces that are at the peripheral regions (FIGS. 13-15), too small (FIG. 16), or among multiple faces (FIG. 17) detected in the input image.

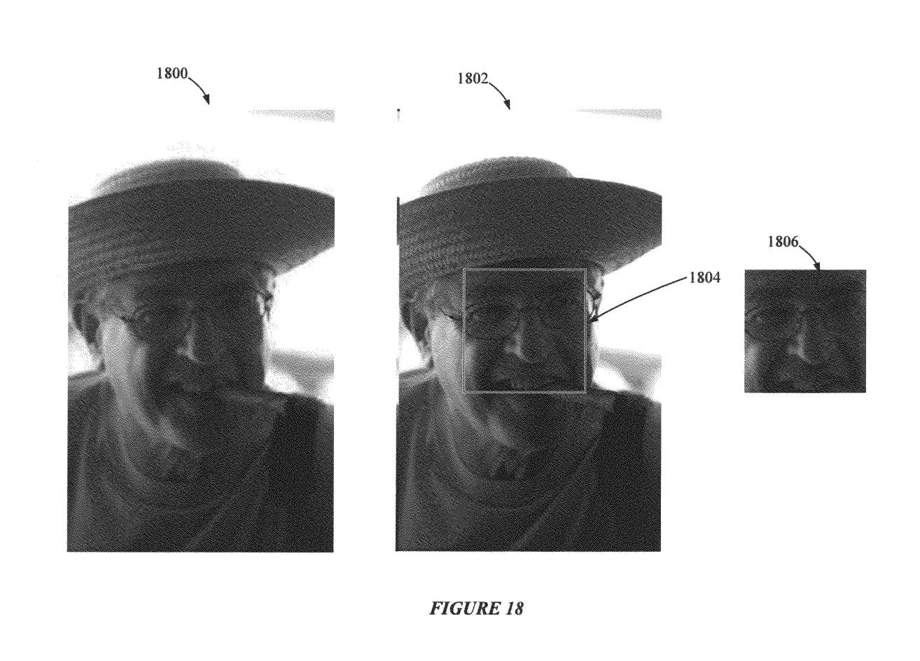

Returning to the flowchart 1100 of FIG. 11, upon a determination at step 1106 that the input image is a portrait scene having a single face meeting the previously discussed masking and size limitations, operations proceed to step 1108. At step 1108 the facial region is cropped. FIG. 18 illustrates an example input image 1800, detected facial region results 1802 of the face 1804, and the cropped facial region 1806. In accordance with this example input image 1800 illustrated in FIG. 18, the facial region darkness and its size relative to the image size are calculated at step 1110. According to one embodiment of the subject application, the backlit category is determined based on the darkness and the size of the facial region as will be appreciated by those skilled in the art.

Suitable methods for detection of backlit faces, i.e. the facial region darkness, include a mid-point approach, as detailed in commonly assigned, co-pending U.S. patent application Ser. No. 12/387,540, filed May 4, 2009, which is incorporated herein. Such approach includes the determination of whether the intensity value at which the accumulated histogram of luminance reaches 50% is below a predetermined threshold value. Any pixels with extreme intensity values are then discarded from the histogram to remove noise. A size is then determined by the ratio of the width of the detected face over the minor dimension of the input image, i.e. to determine if the ratio is above some predetermined threshold value. The resulting comparisons are then used to determine whether a face in an input image is backlit. The skilled artisan will appreciate that other methods of detecting a backlit face are also capable of being implemented in accordance with the methodology set forth in FIG. 11.

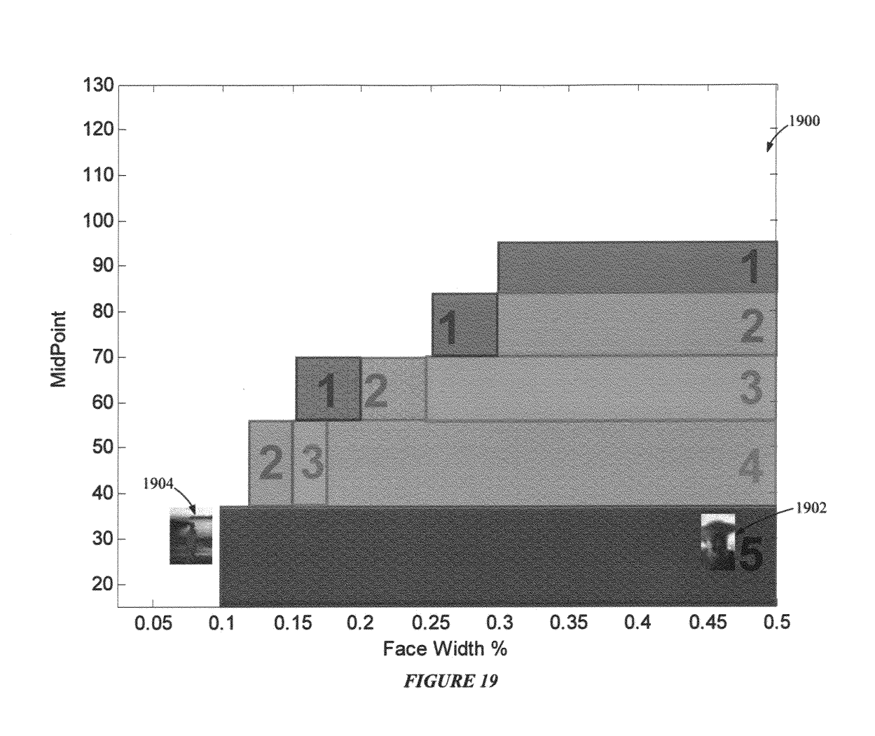

At step 1112, a severity category is calculated for the input image corresponding to a categorization of the relative backlighting of the input image. FIG. 19 shows a chart 1900 of backlit severity categorization in which the X-axis is the relative face size (e.g., the ratio of face width to the minor dimension of the input image) and the Y-axis is the darkness measurement (the mid-point, i.e., the code value at which the normalized image histogram reaches 50%). For example, the face of the input image 1200 in FIG. 12 (shown in FIG. 19 at 1902) is about 45% in size and its mid-point is about 30, therefore, its backlit severity is Category 5. In contrast, the face of the input image 1600 in FIG. 16 (shown in FIG. 19 at 1904) is about as dark but the size is less than 10%, therefore its backlit severity is Category 0 (which means no backlit correction). In accordance with one example embodiment of the subject application, the following is an example pseudo-code for backlit severity categorization:

```
if RelativeSize>=0.1 & MidPoint<37
    category = 5;
elseif RelativeSize>0.2 & MidPoint<55
    category = 4;
elseif RelativeSize>0.175 & MidPoint<55
    category = 3;
elseif RelativeSize>0.125 & MidPoint<55
    category = 2;
elseif RelativeSize>0.25 & MidPoint<70
    category = 3;
elseif RelativeSize>0.2 & MidPoint<70
    category = 2;
elseif RelativeSize>0.15 & MidPoint<70
    category = 1;
elseif RelativeSize>0.3 & MidPoint<85
    category = 2;
elseif RelativeSize>0.25 & MidPoint<85
    category = 1;
elseif RelativeSize>0.45 & MidPoint<95
    category = 1;
else
    category = 0;
end
```

Operations then proceed to step 1114, whereupon facial tone cluster calculations are performed. It will be appreciated by those skilled in the art that the subject application uses the facial tone cluster calculations for a given input image so as to estimate an ethnicity of the detected face of the input image. In accordance with one embodiment of the subject application, adjustments of naturally darker faces of a person of African or Indian descent must be made differently from naturally lighter faces. Facial tone cluster models (light and dark models) are used so as to determine the appropriate category of a detected face in an input image. A facial tone cluster is generated for the detected face and the overlap to the two models is measured. The percentage overlap is used to determine the ethnicity of the input image.

Suitable examples of such cluster calculations are detailed in the commonly assigned, co-pending application Ser. No. 12/592,110, filed Nov. 19, 2009, the entirety of which is incorporated herein. According to such an example of facial tone cluster calculations, a facial tone cluster model is first built by a) collecting typical faces of some specific ethnicities; b) cropping off the facial region; c) removing non-flesh tone regions like eyes, nose and lips; d) converting to CIE L*a*b* color space; and e) round off to integers to form a point set. This model is capable of being enhanced by systematically generating or collecting typical faces under various controlled lighting conditions and merging these faces into the point set. Preferably, two facial tone cluster models are used, one for darker facial tone (African/Indian) and one for lighter facial tone (European). According to one embodiment, the computation cost of such models is reduced by construction of a bounding box for each facial tone cluster model. A binary, three-dimensional matrix M(i,j,k) is then constructed for each model such that when entry in M equals 1, the pixel of code value (i,j,k) in L*a*b* color space is identified as a facial tone color in the model, 0 means otherwise. The boundary data of the models are calculated and stored off-line, and each time the likelihood of ethnicity is to be determined for an input facial region, these boundary data are retrieved from off-line for overlap comparison. Given an input facial region, a) the image is first converted to L*a*b* color space; b) the degrees of overlap to the models representing darker facial tone (African) and lighter facial tone (European) are then ranked to determine the likelihood of ethnicity this input facial region belongs to; and c) the degree of overlap is calculated by counting the total number of pixels in the input facial region that are within the facial tone cluster model boundaries.

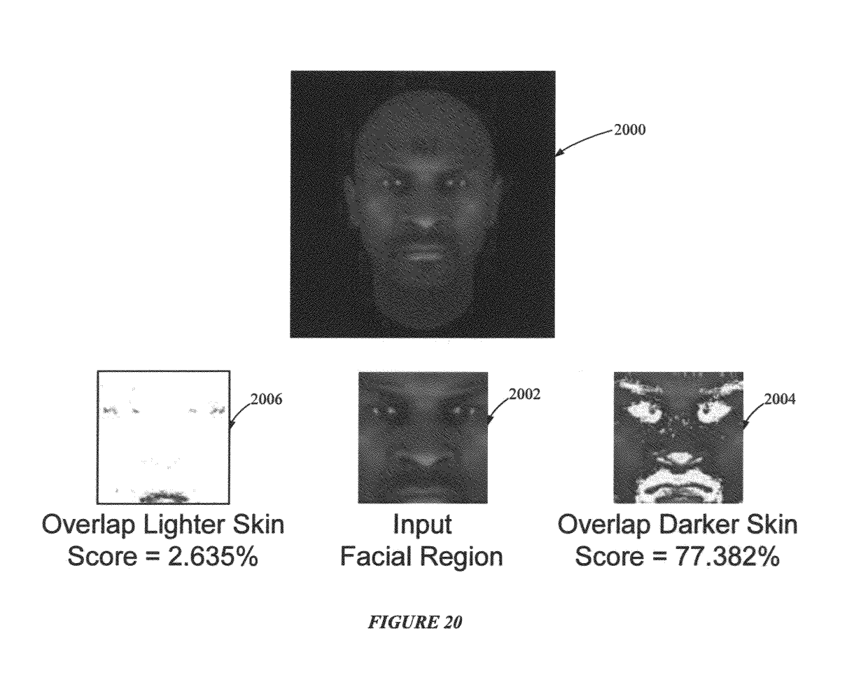

The darkness measure of the cropped facial region is adjusted (by increasing the mid-point value by 50%) if the face is determined by such facial tone cluster calculation that it most likely belongs to an ethnicity with naturally darker skin tone, e.g. African/Indian. FIG. 20 shows such an example: a face 2000 in which the cropped facial region 2002 overlaps with the darker skin tone model by over 70% (overlap image 2004) while it overlaps the lighter skin tone model by less than 3% (overlap image 2006).

A determination is then made at step 1116 whether the input image, based upon the calculated facial tone cluster is an African/Indian ethnicity. Upon a positive determination at step 1116, operations proceed to step 1118, whereupon the mid-point is modified by a predetermined amount, e.g. increased by 50%. The skilled artisan will appreciate that such a modification is capable of being above or below 50%, and the subject application is not limited to this amount. The severity category is then adjusted at step 1120 in accordance with the newly modified mid-point. A determination is then made at step whether the category of the non-African/Indian face (a negative determination at step 1116) or of the adjusted African/Indian face is equal to a severity category of zero (0). If positive at step 1122, operations end with no backlight adjustment made to the input image.

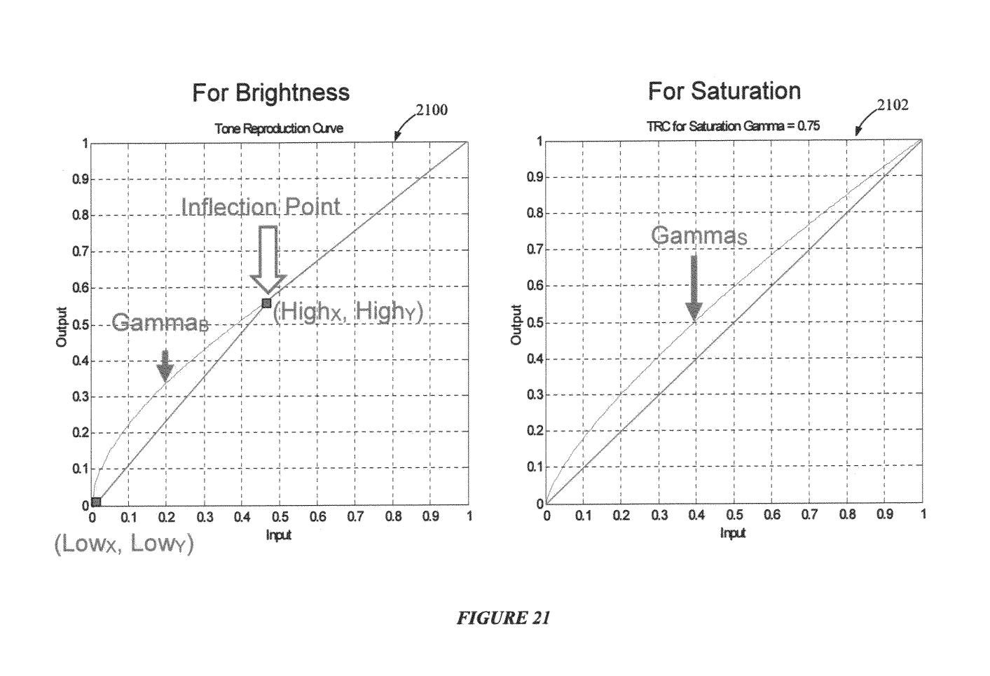

One method for brightness adjustment, e.g. the “Sectional Bulging” approach, as set forth in commonly assigned U.S. patent application Ser. No. 12/194,025, filed Aug. 19, 2008, incorporated herein, applies bulging over a section of the code value interval between two anchor points with a curvature, and after the brightness adjustment, saturation enhancement is applied by bulging with another curvature. FIG. 21 shows the tone reproduction curves for Sectional Bulging for brightness enhancement 2100 and Bulging for saturation enhancement 2102 to compensate the potential loss of color saturation. Thus, there are four parameters in these two tone reproduction curve's: two anchor points, (High_{X}, High_{Y}) and (Low_{X}, Low_{Y}), and two curvature factors, Gamma_{B} for brightness and Gamma_{S} for saturation. The high anchor point, (High_{X}, High_{Y}), is also known as the Inflection Point. The curvature factor specifies the shape of the curve; if it equals 1 then the curve is a straight line; if it is less than 1 then the smaller the factor, the curvier the curve and the mapping is weighted more toward higher output values.

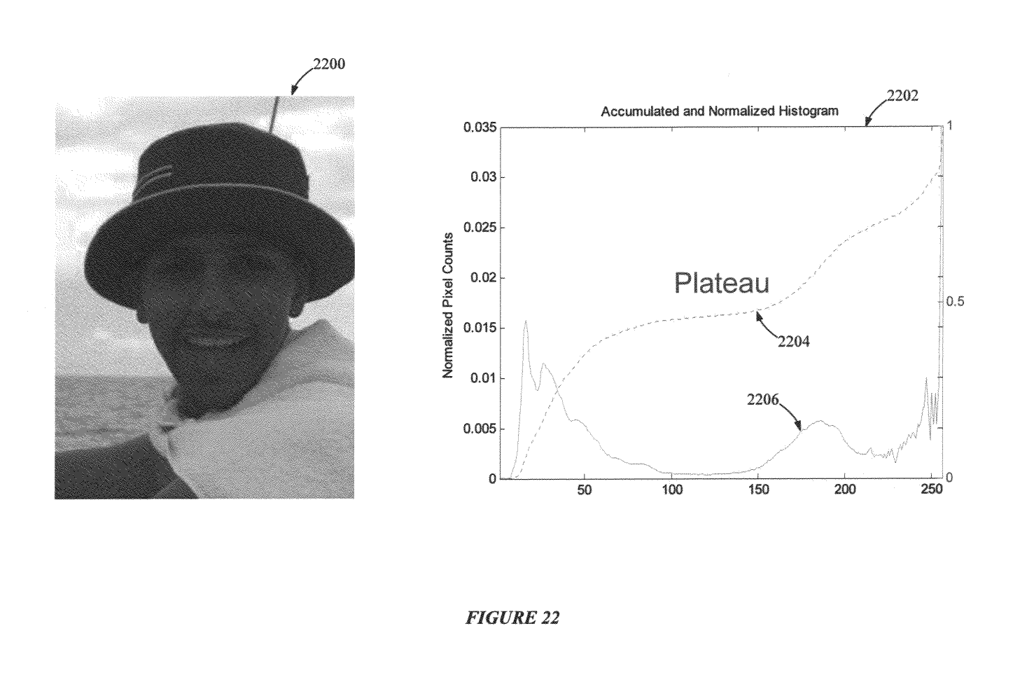

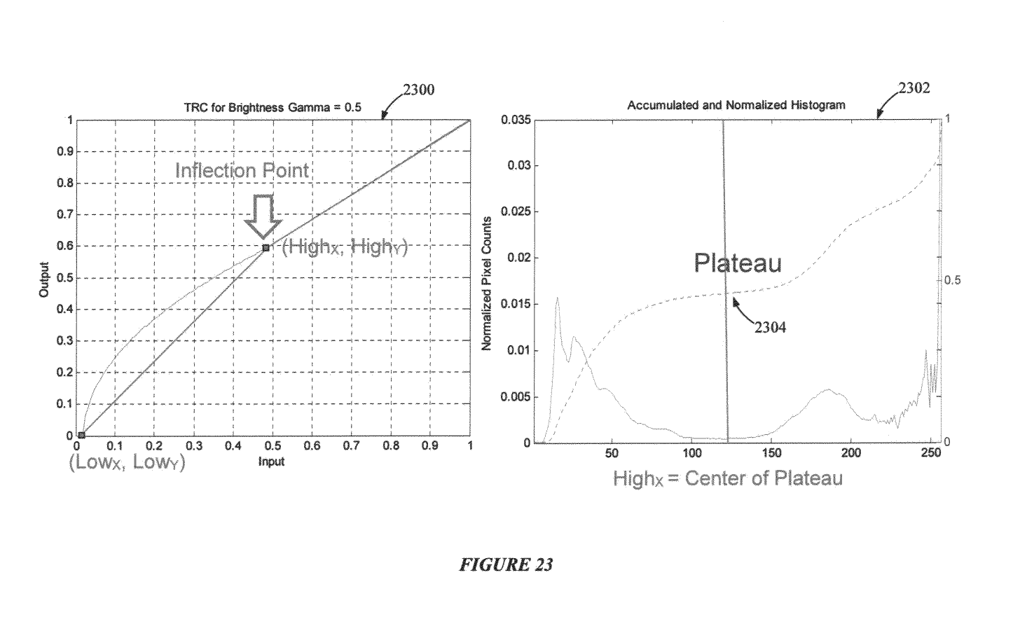

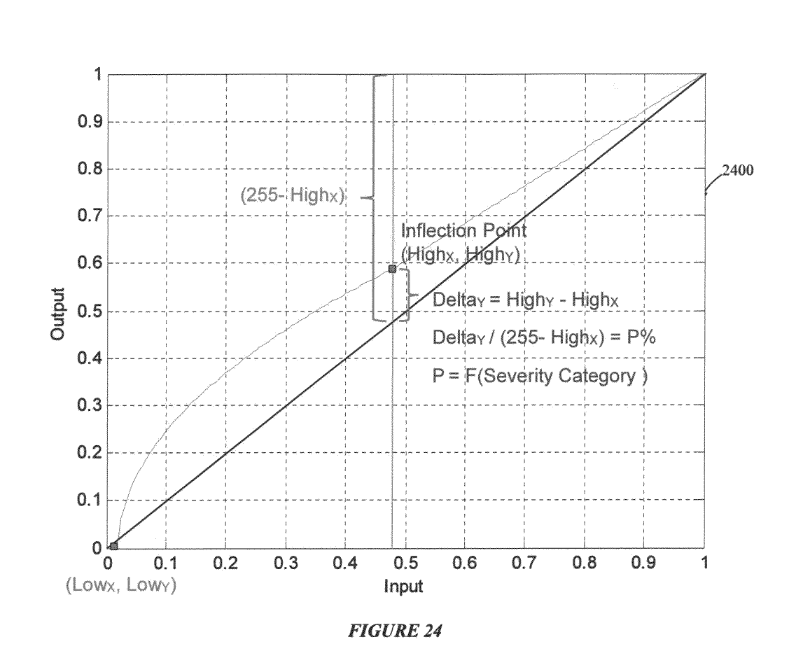

It will be appreciated by those skilled in the art that in a typical backlit scene, there exists a “plateau” phenomenon 2204 in the cumulative histogram (as shown in FIG. 22 as dotted curve in blue corresponding to the histogram 2202 of the input image 2200), i.e., because there is typically a flat region indicating the lack of mid-tone code values 2206 in the normalized histogram 2202 (as shown in FIG. 22 as solid curve in green). Thus, at step 1124, the plateau detection is performed on the normalized histogram of the input image. A determination is then made at step 1126 whether the image includes a plateau. For a typical backlit scene (FIG. 23 depicts the tone reproduction curve 2300 and normalized histogram 2302), the center of the “plateau” 2304 is a candidate for the X-coordinate of the Inflection Point, i.e., High_{X}. The Y-coordinate of Inflection Point is a function of the Severity Category, more specifically, as shown in the tone reproduction curve 2400 of FIG. 24,

High_{Y}=High_{X}+Delta_{Y}, where Delta_{Y}=(255−High_{X})*P%

and the percentage P is a function of the Severity Category. The two curvature factors, Gamma_{B} and Gamma_{S}, are also functions of the Severity Category. The following is the pseudo-code for these parameters:

```
High_{X} = Center of Plateau;
High_{Y} = High_{X} + Delta_{Y} where
    Delta_{Y} = (255 − High_{X}) * 60% if Severity Category = 5;
    Delta_{Y} = (255 − High_{X}) * 45% if Severity Category = 4;
    Delta_{Y} = (255 − High_{X}) * 40% if Severity Category = 3;
    Delta_{Y} = (255 − High_{X}) * 30% if Severity Category = 2;
    Delta_{Y} = (255 − High_{X}) * 15% if Severity Category = 1; and
Gamma_{B} = 0.5 if Severity Category = 5;
Gamma_{B} = 0.55 if Severity Category = 4;
Gamma_{B} = 0.6 if Severity Category = 3;
Gamma_{B} = 0.7 if Severity Category = 2;
Gamma_{B} = 0.8 if Severity Category = 1; and
Gamma_{S} = 0.6 if Severity Category = 5;
Gamma_{S} = 0.7 if Severity Category = 4;
Gamma_{S} = 0.75 if Severity Category = 3;
Gamma_{S} = 0.8 if Severity Category = 2;
Gamma_{S} = 0.85 if Severity Category = 1; and
Low_{X} = Low_{Y} = 3.
```

If a plateau is detected at step 1126, flow proceeds to step 1128, whereupon the X-coordinate of Inflection Point is set as the center of the plateau. If no plateau is detected at step 1126, the X-coordinate of Inflection Point (High_{X}) is set at the default center of 127 at step 1130. At step 1132, the Y-coordinate of Inflection Point and the Bulging Curvatures of the brightness and saturation enhancement by the Severity Category are calculated, i.e. High_{Y}, Gamma_{B}, and Gamma_{S} are calculated. Correction is then performed at step 1134 and the automatically backlit face image is output at step 1136.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A backlit face image correction system comprising:
an input operable to receive image data inclusive of at least one facial region defining an image human face;
a processor operable in accordance with software and an associated data storage, the processor programmed with instructions so as to include,
a face region detector operable to detect the at least one facial region,
a skin tone detector operable to detect skin tone characteristics of the at least one facial region;
a pixel counter operable to calculate pixel count data from the received image data,
a histogram calculator operable to calculate histogram data from the received image data,
a plateau detector operable to detect a plateau in a function of pixel count data relative to histogram data,
a correction factor calculator operable to calculate a correction factor in accordance with a property of a detected plateau, and
an image corrector operable to adjust pixel values of the at least one facial region in accordance with the correction factor; and
an output operable to output a corrected image inclusive of adjusted pixel values corresponding to at least one facial region.

2. The system of claim 1 further wherein the processor is further programmed with instructions so as to further include an ethnicity detector operable on at least one facial region, and wherein the image corrector is further operable to adjust the pixel values of the at least one facial region in accordance with an output of the ethnicity detector.

3. The system of claim 2 wherein the correction factor calculator is operable to calculate the correction faction in accordance with gamma values corresponding to the detected plateau.

4. The system of claim 3 wherein the processor is further programmed with instructions so as to, for each facial region, calculate mid-point data corresponding to a darkness measurement of a central portion thereof, and wherein the skin tone detector is operable on the mid-point data.

5. The system of claim 4 wherein the processor is further programmed with instructions so as to calculate adjusted mid-point data in accordance with an output of the ethnicity detector.

6. The system of claim 5 wherein the processor is further programmed with instructions so as to assign a preselected value to at least one of the gamma values when the plateau detector fails to indicate a presence of a functional plateau in the histogram data.

7. The system of claim 6 wherein the histogram calculator is further operable to calculate the histogram data as normalized histogram data.

8. A method of backlit face image correction comprising:
receiving image data inclusive of at least one facial region defining an image human face;
in a processor operable in accordance with software and an associated data storage,
detecting the at least one facial region,
detecting skin tone characteristics of the at least one facial region;
calculating pixel count data from the received image data,
calculating histogram data from the received image data,
detecting a plateau in a function of pixel count data relative to histogram data,
calculating a correction factor in accordance with a property of a detected plateau, and
adjusting pixel values of the at least one facial region in accordance with the correction factor; and
outputting a corrected image inclusive of adjusted pixel values corresponding to at least one facial region.

9. The method of claim 8 further comprising:
detecting an ethnicity of an image contained in the at least one facial region; and
adjusting the pixel values of the at least one facial region in accordance with a detected ethnicity.

10. The method of claim 9 further comprising calculating the correction faction in accordance with gamma values corresponding to the detected plateau.

11. The method system of claim 10 further comprising calculating, for each facial region, mid-point data corresponding to a darkness measurement of a central portion thereof, and wherein the step of detecting skin tone characteristics includes the step of detecting the skin tone characteristics in accordance with the mid-point data.

12. The method of claim 11 further comprising calculating adjusted mid-point data in accordance with a detected ethnicity.

13. The method of claim 12 further comprising assigning a preselected value to at least one of the gamma values upon a failure to detect a presence of a functional plateau in the histogram data.

14. The method of claim 13 further comprising calculating the histogram data as normalized histogram data.
